(19) United States
(12) Patent Application Publication
(10) Pub. No.: US 2004/0061706 A1
(43) Pub. Date: Apr. 1, 2004

(54) Presentation of data to be displayed in a wireless network

(76) Inventors: Thomas M. Cronin, Hillsboro, OR (US); Marion H. Shimoda, Aloha, OR (US); Rajesh P. Banginwar, Hillsboro, OR (US); Travis T. Shultz, Hillsboro, OR (US); Roger A. Hurwitz, Portland, OR (US)

Correspondence Address: TROP, PRUNER & HU, P.C., Suite 100, 8554 Katy Freeway, Houston, TX, 77024, US

(21) Appl. No.: 10/260,745

(22) Filed: Sep. 30, 2002

(51) Int. Cl. G09G 5/00

(52) U.S. Cl. 345/629

(57) ABSTRACT

A device that may be part of a wireless network may support a service that may adjust the presentation of client image data on a display. Client image data may be adjusted for display on either the entire display screen or a portion thereof.

### BACKGROUND

This invention relates generally to wireless networks.

Many devices that are part of a wireless network may have their own display. For example, a desktop PC, personal digital assistant (PDA) and cellular telephone may be part of a wireless network, each with its own display. In some instances a user may wish to view one display that includes information from one or more of the network components. However, a given network device may only allow one other network device at a time access to its display.

In other instances it may be desirable to display the same information on one or more network devices. For example, one person may want to present data to other persons in a group, each using a display device that is part of the wireless network. However, one or more of the networked displays may have different dimensions and resolutions. Thus, a user interface may not be appropriately formatted for display on the desired network devices.

Thus, there continues to be a need for improved ways to display information on a wireless network device where the information to be displayed comes from another device that is part of substantially the same wireless network.

### BRIEF DESCRIPTION OF THE DRAWINGS

FIG. 1 is a schematic depiction of a wireless network in accordance with some embodiments of the present invention;

FIG. 2 is a flow chart for software for subdividing a display on a wireless display sponsor according to some embodiments of the present invention;

FIG. 3 is a subdivided display according to some embodiments of the present invention;

FIG. 4 is alternate embodiment of the subdivided display according to another embodiment of the present invention;

FIG. 5 is a flow chart for software for dynamically formatting image data for presentation of a user interface on a wireless display sponsor according to some embodiments of the present invention;

FIG. 6 is a flow chart for software for transferring image data from a display client according to some embodiments of the present invention; and

FIG. 7 is a block depiction of a wireless processor-based system in accordance with some embodiments of the present invention.

### DETAILED DESCRIPTION

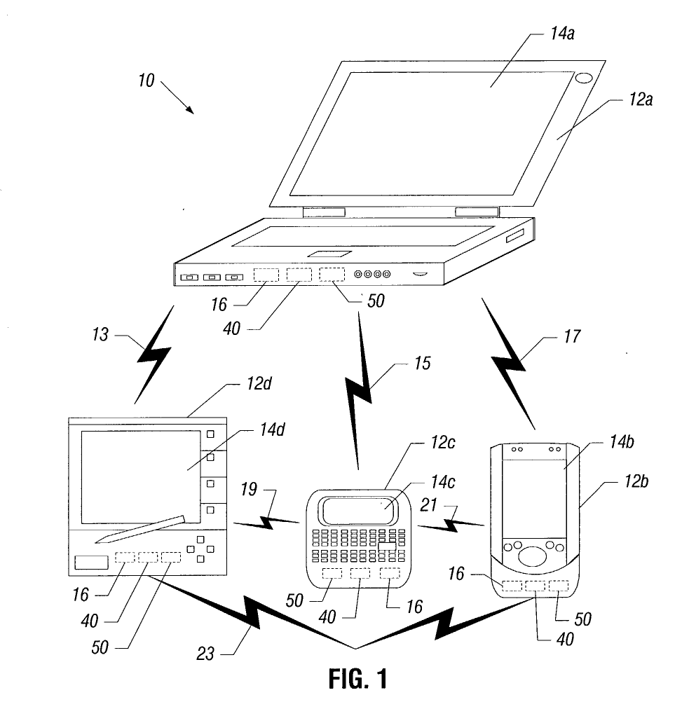

Referring to FIG. 1, a wireless network 10 may include a plurality of display devices 12. For example, the wireless network 10 may include a laptop computer 12a, a personal digital assistant (PDA) 12b, a two way pager 12c and a pen computer 12d. Although four devices 12 are illustrated in FIG. 1, any number or variety of different devices may be included in the network 10, including peripheral devices and the scope of the present invention is not limited in this respect. Moreover, the number of devices that are part of the network may be determined by the applicable wireless communication standard, such as the Bluetooth standard or the I.E.E.E. standard 802.11 as examples. The Bluetooth protocol allows for short-range wireless communications between devices and peripherals. See a complete description of the Bluetooth specification in two sections: A Core Specification (Volume I) and Definitions (Volume II) Profile published July, 1999, which are available on the Internet at the Bluetooth official website. In contrast, the Institute of Electrical and Electronics Engineer specification 802.11 (I.E.E.E. 802.11) allows for longer-range wireless communications between processor-based devices and peripherals. See the I.E.E.E. 802.11 standard entitled “I.E.E.E. Standard 802.11 1999 Edition”, which may be obtained from the I.E.E.E. Customer Service Center, 445 Hoes Lane, P.O. Box 1331, Piscataway, N.J. 08855-1331.

According to the Bluetooth standard, a wireless network may be formed when enabled devices come within about 10 meters of each other. Thus, a variety of devices including peripherals may enter and leave the network in an ad hoc fashion. While part of the network, different processor-based systems may communicate directly with each other.

Once part of the network 10, it may be desirable to present image data that is obtained from one or more display devices 12 on a display 14 that is associated with another display device 12. For example, it may be desirable to simultaneously present information that is obtained from the PDA 12b, two-way pager 12c and pen computer 12d on the display 14a of the laptop computer 12a. Alternately, it may be desirable to present information that is obtained from the laptop computer 12a on the display 14 of the PDA 12b, two-way pager 12c and pen computer 12d. In either case, according to embodiments of the present invention, one or more display services 16 and 40 and software module 50 resident on the display device 12 may coordinate the actions for implementing the desired presentation outcome. As used herein, the term image data refers to any data or information relating to any object, letter, number, graphic, image, text, picture, photograph, table or the like. Thus, the scope of the present invention is not limited in this respect.

The display services 16 and 40 may be provided by a service model based infrastructure such as Universal Plug and Play (UPnP) or Jini™ as examples. However, the scope of the present invention is not limited in this respect. Generally, UPnP and Jini™ technologies facilitate building networks with little or no user involvement.

UPnP is defined by the Universal Plug and Play forum. Available standards, specifications and other documents are available over the Internet on the Forum's official website. Likewise, the Jini™ technology specification v1.2 is available over the Internet on Sun® Microsystems' Official website.

According to some embodiments of the present invention, one or more display devices 12 may act as a display client by querying the network 10 for example over a wireless link such as link 13, 15, 17, 19, 21 or 23 to determine if a particular display service is available. When the display client locates the display service, one or more display devices 12 supporting the service may act as a display sponsor by processing the image data obtained from the display client over a wireless link 13, 15, 17, 19, 21 or 23 for display on the display 14 associated with the sponsor. Alternately, in other embodiments, the display sponsor may announce over wireless link 13, 15, 17, 19, 21 or 23 that the sponsor supports a particular display service. Thereafter, one or more display clients may request over wireless link 13, 15, 17, 19, 21 or 23 the use of the display service. Thus, the display devices 12 in the wireless network 10 may act either as a display client or a display sponsor. Moreover, a display device 12 that previously acted as a display client may reverse roles to act as a display sponsor and vice versa. Communications between all network devices, display devices and peripherals alike may be over a wireless link such as link 13, 15, 17, 19, 21 or 23.

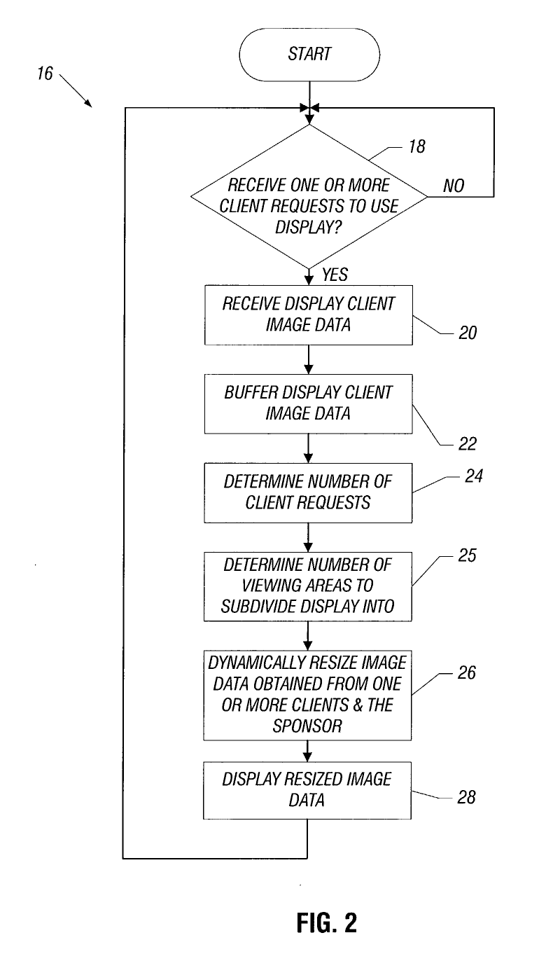

In one embodiment of the present invention as shown in FIG. 2, the software module to provide a display service 16 automatically subdivides the display 14 associated with display sponsor into a plurality of viewing areas. As used herein, “automatic”, “automatically” and derivatives thereof generally means that a service does not require user input for execution, rather, once client data is received over a wireless link, it may be processed without requiring user input.

The display service 16 may begin when one or more requests from display clients are received by the display sponsor as shown in diamond 18. When no requests are received, the display 14 may be dedicated to the display sponsor. However, when one or more clients request the use of the display 14 associated with the display sponsor, the display sponsor may receive image data from the requesting display clients as shown in block 20. Client image data may be in the form of a bit mapped image data as one example. However, the scope of the present invention is not limited to bit-mapped image data.

Thereafter, the display sponsor may buffer the image data received from the requesting display clients in its own virtual display memory area at full resolution as shown in block 22. The software for the service 16 may determine the number of client requests, as shown in block 24. Thereafter, the number of viewing areas that the display is to be divided into may be determined as shown in block 25. The number of viewing areas that the display 14 associated with the display sponsor is subdivided into may be based in part on the number of client requests that the display sponsor receives. For example, when there are three client requests, the service 16 may determine that the display 14 should be subdivided into four viewing areas, one for each client and one for the display sponsor. Thereafter, the display service 16 may dynamically resize the image data obtained from one or more display clients and the display sponsor as shown in block 26. Image data may be resized to occupy one of the viewing areas. When the image data for one or more display devices 12 is resized, it may be presented in one of the viewing areas on the display sponsor's physical display, as shown in block 28. In this way, display quality may be retained as the viewing areas change in size.

Subdividing the display into an appropriate number of viewing areas may depend in part upon the number of client requests that the display sponsor receives. As an illustration only, in which the scope of the present invention is not limited, referring back to FIG. 1, the laptop 12a may be designated as a display sponsor. One or more of the PDA 12b, two-way pager 12c and pen computer 12d may act as a client. Accordingly, one or more client devices 12b, 12c and 12d may detect the service 16 and may request the use of the laptop's 12a display 14a. The sponsor laptop 12a may receive image data transmitted from one or more client devices 12b, 12c and 12d. To retain image quality, the service 16 may buffer one or more client's 12b, 12c and 12d image data. In this example there are three client requests. Thus, when determining the appropriate number of viewing areas to divide the sponsor display 14a into, the service 16 may fashion an area for the display of data received from one or more clients 12b, 12c and 12. Moreover, the service 16 may retain a viewing area to display the sponsor's 12a data. When the appropriate number of viewing areas is determined, display service 16 may dynamically resize the image data obtained from one or more client 12b, 12c and 12d for presentation on the sponsor display 14a. In some embodiments, the display sponsor's 12a data may also be resized before display.

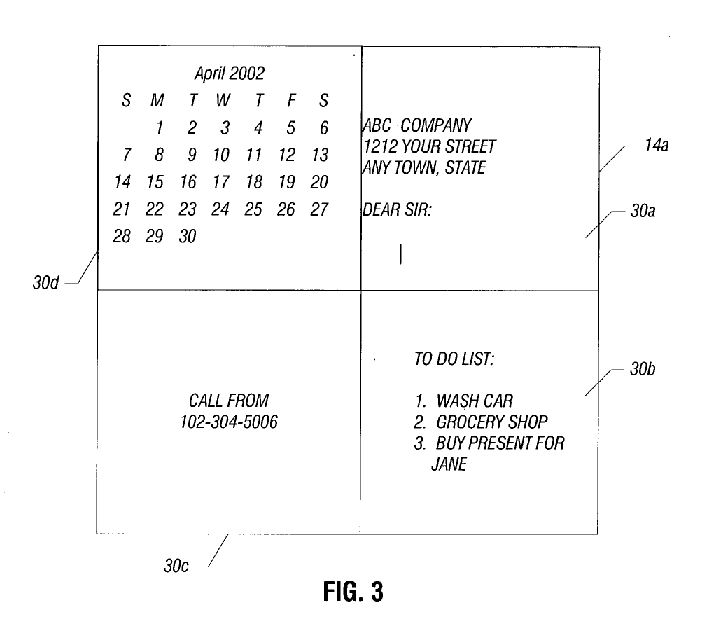

According to one embodiment, display service 16 may subdivide the sponsor display into substantially equal viewing areas, as shown in FIG. 3. Thus, according to the above example, the display 14a on the laptop 12a may be divided into substantially four equal viewing areas 30a, 30b, 30c and 30d. One viewing area 30a may be for the presentation of the sponsor's 12a image data. The other three viewing areas 30b, 30c and 30d may be allocated for presentation of data obtained from the PDA 12b, two-way pager 12c and pen computer 12d respectively in this example. When resizing image data, display service 16 may attempt to retain the same aspect ratios.

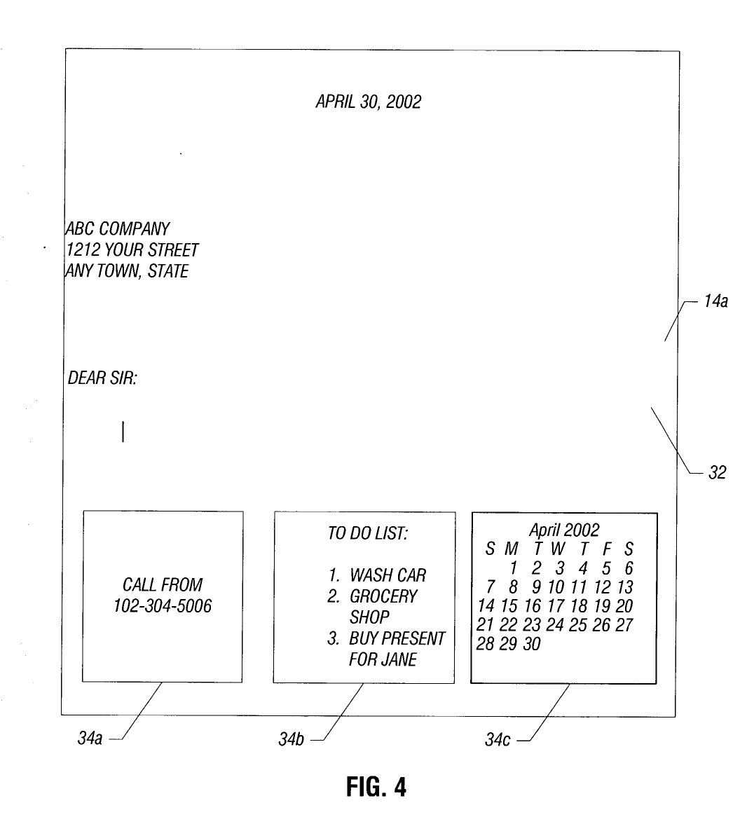

In an alternate embodiment, display service 16 may subdivide the sponsor display into unequal viewing areas, as shown in FIG. 4. According to the present example, the display 14a on the laptop 12a may still be subdivided into four viewing areas. However, one area 32 may be a primary viewing area whereas those areas remaining may be secondary viewing areas 34. In this example, the primary viewing area 32 may be retained for displaying the laptop's 12a image data. However, the image data obtained from any one of the client devices may occupy the primary viewing area 32. Likewise, according to the example, the secondary viewing areas 34a, 34b and 34c may be fashioned for displaying client image data 12c, 12b and 12d respectively. However, the sponsor's 12a image data may just as easily occupy a secondary viewing area 34. Secondary viewing areas may be picture-in-picture windows or pop-up windows. Again, the image data received from one or more clients may be resized for display in a designated viewing area. When doing so, display service 16 attempts to retain the same aspect ratios. Additionally, in this embodiment, the display sponsor's image data may or may not be resized.

It should be noted that the embodiments outlined above are only two of the possible ways to divide display space and the scope of the present invention is not limited in this respect.

Allocation of display space may be updated when a display device 12 enters or leaves the network 10 or when the display sponsor receives one or more additional requests for use of the sponsor's display. Moreover, in some embodiments of the present invention, an allocated viewing area may be retained for use by a given client or sponsor device should the client or sponsor temporarily become inactive or leave the network 10.

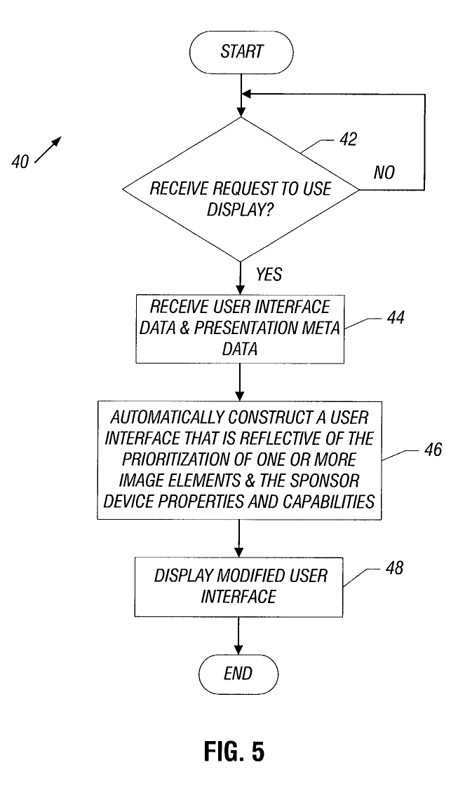

An alternate display service 40 as shown in FIG. 5 may dynamically format a user interface that is obtained from a client device to occupy a viewing area on one or more sponsor devices. In some embodiments of the present invention, the software for the display service 40 may be utilized alone or in conjunction with display service 16. Moreover, in embodiments of the present invention, during interface development image elements have been prioritized and/or grouped in a logical manner according to their importance. For example, required elements or the most important features of the interface may be given a higher priority whereas optional elements or elements of lesser importance may be given a lower priority. The prioritization and grouping of image elements may be similar to a HyperText Markup Language (HTML) form although the scope of the present invention is not limited in this respect. As used herein, the term image element is intended to include any element that may be displayed on a user interface such as objects, letters, numbers, graphics, photographs, pictures, text, tables and images as a few examples. However, the scope of the present invention is not limited to these examples.

The prioritization and/or grouping of the interface image elements may be stored as presentation metadata that is associated with the user interface data. Thus, when a display sponsor receives a request from a client to utilize its display as shown in diamond 42, that display sponsor may receive interface data and presentation metadata from a client as shown in block 44. When the interface data and presentation metadata are received, the display service 40 may construct a user interface that may reflect the prioritization of one or more image elements and the display properties and capabilities for that particular sponsor device as shown in block 46. When finished constructing the user interface for a particular display sponsor, the display service 40 may display the modified user interface as shown in block 48.

As an illustration, which does not limit the scope of the present invention, please refer to FIG. 1. It may be desirable to present a user interface obtained from the laptop 12a on the display 14 of the PDA 12b, two-way pager 12c and pen computer 12d. Accordingly, when the display service 40 is recognized by the client laptop 12a, the client 12a may send a request to one or more sponsor devices 12b, 12c and 12d to use one or more sponsor 12b, 12c or 12d displays 14. Alternately, in some embodiments, the display sponsor 12b, 12c and/or 12d may request user interface data from the client 12a. In either embodiment, one or more sponsor devices 12b, 12c and 12d may receive interface data and presentation metadata from the client 12a. Thereafter, the service 40 may format the client 12a data pursuant to the prioritization and/or grouping of one or more image elements and the dimension and resolution of the particular display 14b, 14c or 14d.

When formatting the user interface for presentation on one or more sponsor devices 12b, 12c and/or 12d, the required interface elements may be displayed first and most prominently. Moreover, the display service 40 may also take the particular sponsor's display size and resolution into account when formatting interface image elements for presentation. Thus, when going from a display client with a larger viewing area to one or more display sponsors with a smaller viewing area, some of the interface image elements may appear on one screen whereas other interface elements may appear on subsequent screens. Those interface elements that appear on the first screen may be required elements having higher priority whereas image elements on subsequent screens may be optional elements of lower priority. Navigation between screens may be by any conventional means such by depressing a next button or key although the scope of the invention is not limited in this respect. In this way, a graphical user interface viewed on one display device 12 in a wireless network may be modified for viewing on another display device 12 within the network 10 in a seamless, logical manner.

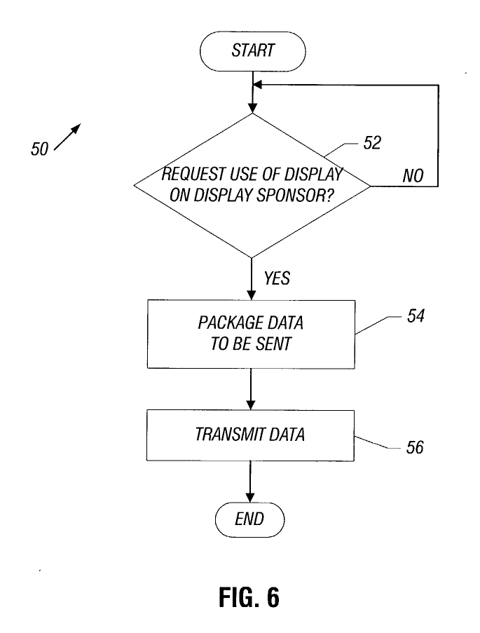

Referring to FIG. 6, one or more display devices 12 that may act as a client may have software module 50. The software module 50 may have instructions for transferring image data, and when applicable presentation metadata, to one or more display sponsors in one embodiment. When in the client mode, the display device 12 may request the use of one or more displays 14 via the associated display sponsor as shown in block 52. When the request is received by a display sponsor that supports a display service 16 and/or 40, the client display device may package the client's interface data as shown in block 54 and may transmit that data as shown in block 56 to one or more receiving display sponsors. Packetizing the client interface data may be done by methods known in the art.

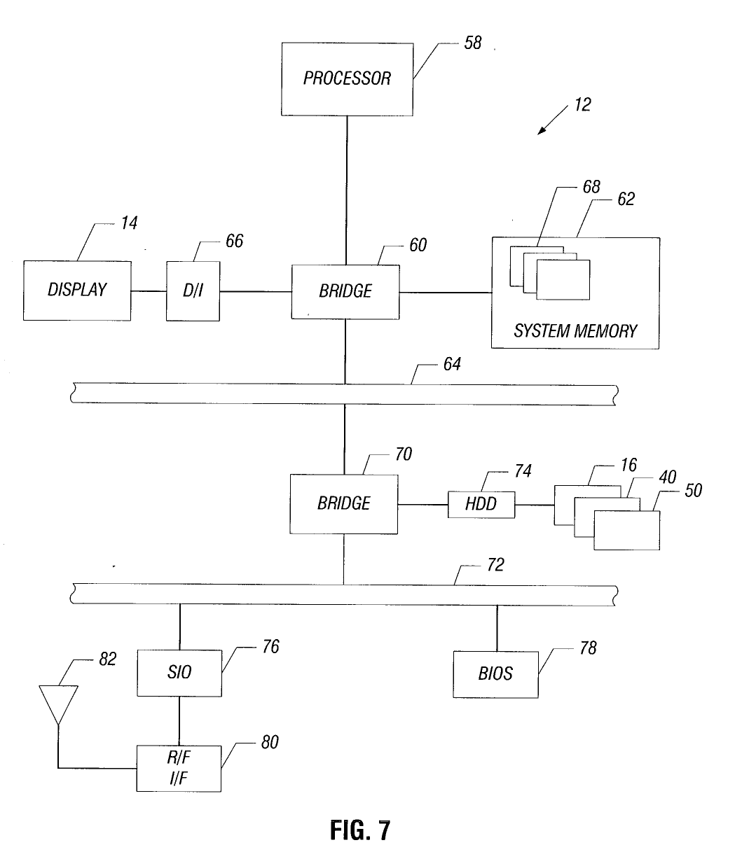

Referring to FIG. 7, in one embodiment one or more of the display devices 12 that are part of the wireless network 10 may include a processor 58 coupled to a bridge 60. The bridge 60 may be coupled to a system memory 62, a bus 64 and a display interface 66. The system memory 62 may include a buffer 68 for the virtual display of client image data. Moreover, the memory 62 may be any suitable memory such as an Electrically Erasable Programmable Read Only Chip (EEPROM), a flash memory or a Programmable Read Only Memory (PROM) as a few examples, although the scope of the present invention is not limited in this respect. The display interface 66 may be coupled to the display 14.

Bus 64 may be coupled to a bridge 70, which may be coupled to a hard disk drive 74 and a bus 72. Hard disk drive 74 may store software for services such as display service 16 that subdivides a sponsor display into a plurality of viewing areas, display service 40 that modifies client interface data for presentation on a display sponsor and software module 50 that transmits client image data to a display sponsor. The bus 72 may be coupled to a serial input/output (SIO) 76 and a basic input/output system (BIOS) 78. The SIO 76, in turn, is coupled to a radio frequency (RF) interface 80, which is coupled to an antenna 82 such as a dipole antenna as one example, although the scope of the present invention is not limited in this respect.

The above architecture is exemplary for a processor-based device of a wireless network. However, any appropriate architecture may be utilized or modified for a particular device and the scope of the present invention is not limited in this respect.

While the present invention has been described with respect to a limited number of embodiments, those skilled in the art will appreciate numerous modifications and variations therefrom. It is intended that the appended claims cover all such modifications and variations as fall within the true spirit and scope of this present invention.

What is claimed is:

1. A method comprising:
receiving image data from one or more client devices; and
presenting said client image data on a display such that the presentation of said client image data on said display is different from the presentation of the same image data on the client device.

2. The method of claim 1 wherein presenting said client image data comprises automatically dividing said display into one or more viewing areas such that said client image data received from one of said clients is displayed in one of said viewing areas while said client image data received from another of said clients is displayed in another of said viewing areas.

3. The method of claim 2, wherein automatically dividing said display into one or more viewing areas comprises determining the number of client requests received and dividing said display into one or more of said viewing areas based on the determined number of client requests.

4. The method of claim 3, wherein determining the number of client requests comprises determining that one of said client requests was received from the client that supports said display.

5. The method of claim 3, wherein automatically dividing said display into one or more of said viewing areas includes automatically dividing said display into one or more substantially equal viewing areas.

6. The method of claim 3, wherein automatically dividing said display into one or more of said viewing areas includes automatically dividing said display into one or more unequal viewing areas.

7. The method of claim 4, further including buffering said image data in a virtual display memory area.

8. The method of claim 7, further including dynamically resizing said image data received from one of said clients to be displayed in one of said viewing areas and dynamically resizing said image data received from another of said clients to be displayed in another of said viewing areas.

9. The method of claim 1 wherein presenting said client image data on said display comprises presenting a user interface having one or more image elements that are prioritized as a higher priority image element or a lower priority image element, said prioritization received with said image data as presentation metadata, and automatically and dynamically constructing said user interface that reflects the prioritization of said image elements.

10. The method of claim 9, further including grouping said higher priority interface image elements and said lower priority interface image elements in a logical manner.

11. The method of claim 10, further including displaying said higher priority image elements on a first display screen.

12. The method of claim 11, further including displaying said lower priority image elements on a subsequent display screen.

13. An article comprising a medium storing instructions that, when executed result in:
receiving image data from one or more client devices; and
presenting said client image data on a display such that the presentation of said client image data on said display is different from the presentation of the same image data on the client device.

14. The article of claim 13 comprising a medium storing instructions that, when executed result in automatically dividing said display into one or more viewing areas such that said client image data received from one of said clients is displayed in one of said viewing areas while said client image data received from another of said clients is displayed in another of said viewing areas.

15. The article of claim 14 comprising a medium storing instructions that, when executed result in determining the number of client requests received and dividing said display into one or more of viewing areas based on the determined number of client requests.

16. The article of claim 15 comprising a medium storing instructions that, when executed result in determining that one of said client requests was received from the client that supports said display.

17. The article of claim 15 comprising a medium storing instructions that, when executed result in automatically dividing said display into one or more substantially equal viewing areas.

18. The article of claim 15 comprising a medium storing instructions that, when executed result in automatically dividing said display into one or more unequal viewing areas.

19. The article of claim 16 comprising a medium storing instructions that, when executed result in buffering said image data in a virtual display memory area.

20. The article of claim 19 comprising a medium storing instructions that, when executed result in dynamically resizing said image data received from one of said clients to be displayed in one of said viewing areas and dynamically resizing said image data received from another of said clients to be displayed in another of said viewing areas.

21. The article of claim 13 comprising a medium storing instructions that, when executed result in presenting a user interface having one or more image elements that are prioritized as a higher priority image element or a lower priority image element, said prioritization received with said image data as presentation metadata, and automatically and dynamically constructing said user interface to reflect the prioritization of said image elements.

22. The article of claim 21 comprising a medium storing instructions that, when executed result in grouping said higher priority interface image elements and said lower priority interface image elements in a logical manner.

23. The article of claim 22 comprising a medium storing instructions that, when executed result in prominently displaying said higher priority image elements.

24. The article of claim 23 comprising a medium storing instructions that, when executed result in displaying said higher priority image elements on a first display screen and said lower priority image elements on a subsequent display screen.

25. An apparatus comprising:
a flash memory to receive image data from one or more client devices over a wireless link; and
a processor operabley coupled to said flash memory and to a display and to present said client image data on said display such that said presentation of said client image data is different from the presentation of the same image data on the client device.

26. The apparatus of claim 25 wherein said presentation of said client image data comprises automatically dividing said display into one or more viewing areas such that said client image data received from one of said clients is displayed in one of said viewing areas while said client image data received from another of said clients is displayed in another of said viewing areas.

27. The system of claim 25 wherein the presentation of said client image data on said display comprises presenting a user interface having one or more image elements that are prioritized as a higher priority image element or a lower priority image element, said prioritization received with said image data as presentation metadata, and automatically and dynamically constructing said user interface to reflect the prioritization of said image elements.

28. A method comprising:
prioritizing one or more user interface image elements as a higher priority image element or a lower priority image element; and
storing said prioritization of said user interface image elements as presentation metadata that is associated with the data for a user interface, such that said user interface is enabled to be constructed to reflect said prioritization.

29. The method of claim 28 further including enabling said higher priority image elements to be displayed on a first display screen.

30. The method of claim 29 further including enabling said lower priority image elements to be displayed on a subsequent screen.
